(19) United States
(12) Patent Application Publication
(10) Pub. No.: US 2024/0416996 A1
(43) Pub. Date: Dec. 19, 2024

(54) VEHICLE BODY STRUCTURE

(71) Applicant: HONDA MOTOR CO., LTD., Minato-ku (JP)

(72) Inventors: Masayasu Yoshida, Wako-shi (JP); Satoru Kawabe, Wako-shi (JP); Hiroyo Miyanaga, Wako-shi (JP); Hisashi Suzuki, Wako-shi (JP)

(21) Appl. No.: 18/676,550

(22) Filed: May 29, 2024

(30) Foreign Application Priority Data
Jun. 13, 2023 (JP) 2023-096860

(51) Int. Cl. B62D 21/02; B62D 25/02

(52) U.S. Cl. CPC B62D 21/02; B62D 25/02

(57) ABSTRACT

A vehicle body structure includes: an upper panel and a lower panel; and a left rear side frame and a right rear side frame that are connected to a vehicle width direction outer side of each panel and extend in a vehicle forward-rearward direction. The left rear side frame has a first stiffness change region and a second stiffness change region. The first stiffness change region and the second stiffness change region are provided on an inner side surface and an outer side surface of the left rear side frame. The second stiffness change region is provided at a different position in a longitudinal direction from the first stiffness change region.

### CROSS-REFERENCE TO RELATED APPLICATION

Priority is claimed on Japanese Patent Application No. 2023-096860, filed on Jun. 13, 2023, the contents of which are incorporated herein by reference.

### BACKGROUND

### Field of the Invention

The present invention relates to a vehicle body structure.

### Background

In recent years, efforts have been made to provide access to sustainable transportation systems. In order to realize this, research and development for further improving traffic safety or convenience has been focused on through developments relating to vehicle body stiffness. For example, a vehicle body structure is known in which a side frame is provided on right and left sides in a vehicle width direction of a panel, and the side frame extends in a vehicle forward-rearward direction.

The side frame includes a side frame main body and an upper wall member provided on an upper portion of the side frame main body. A plurality of fragile portions are formed at intervals in a longitudinal direction (vehicle forward-rearward direction) on a lower portion of the side frame main body. A bend start point portion is provided on the upper wall member. According to the vehicle body structure, when an impact load is input from a vehicle forward direction or a vehicle rearward direction, the impact load can be absorbed by deforming the side frame so as to be bent in an upward-downward direction by the fragile portion and the bend start point portion (for example, refer to Japanese Unexamined Patent Application, First Publication No 2021-160412).

### SUMMARY

In the related art described above, since the impact load is absorbed by deforming the side frame in the upward-downward direction, it is difficult to sufficiently deform a panel in association with the side frame. Therefore, there is room for improvement in load absorption efficiency by sufficiently deforming the panel in association with the side frame.

An aspect of the present invention aims to provide a vehicle body structure that can improve load absorption efficiency by a side frame and a panel and contributes to the development of a sustainable transportation system.

(1) A vehicle body structure according to an aspect of the present invention includes: a panel provided on a vehicle lower part; and a side frame that is connected to a vehicle width direction outer side of the panel and extends in a vehicle forward-rearward direction, wherein the side frame has a plurality of stiffness change regions, the plurality of stiffness change regions are provided on a vehicle width direction outer side and a vehicle width direction inner side of the side frame, and the stiffness change region provided on the vehicle width direction outer side is provided at a different position in a longitudinal direction from the stiffness change region provided on the vehicle width direction inner side.

According to such a configuration, the stiffness change regions are provided on the vehicle width direction outer side and the vehicle width direction inner side of the side frame. Therefore, when an impact load is input to the side frame from the vehicle forward-rearward direction, the side frame can be deformed so as to be bent to the vehicle width direction outer side and the vehicle width direction inner side from the stiffness change region as a starting point. By the side frame deforming so as to be bent, the input impact load is absorbed.

The panel is connected to the side frame. Therefore, by the side frame being bent to the vehicle width direction outer side and the vehicle width direction inner side from the stiffness change region, a load is transmitted from the side frame to the panel. Specifically, a load that compresses the panel to the vehicle width direction inner side or a load that extends the panel to the vehicle width direction outer side is transmitted from the side frame to the panel. Further, a load that deforms the panel in the vehicle forward-rearward direction is transmitted from the side frame to the panel. Thereby, it is possible to efficiently transmit the load to the entire region of the panel, and it is possible to suitably deform the entire region of the panel.

Additionally, the stiffness change region on the vehicle width direction outer side and the stiffness change region on the vehicle width direction inner side are provided at a different position in the longitudinal direction of the side frame. Thereby, the side frame can be deformed so as to be suitably bent from the stiffness change region as a starting point without concentrating stress on part of the side frame.

By suitably deforming the side frame and suitably deforming the entire region of the panel, it is possible to improve the load absorption efficiency by providing the side frame and the panel. Further, it is possible to contribute to the development of a sustainable transportation system.

(2) In the aspect described above, a fragile portion that is continuous in a vehicle width direction may be provided on a vehicle upper side and a vehicle lower side of the side frame.

According to such a configuration, the fragile portion can be deformed together with the stiffness change region on the vehicle width direction outer side and the stiffness change region on the vehicle width direction inner side. Thereby, it is possible to further suitably promote deformation of bending the side frame in the vehicle width direction from the stiffness change region as a starting point.

Further, it is possible to prevent buckling of the side frame by stress concentration and suitably bend the side frame in the vehicle width direction from the stiffness change region as a starting point. Therefore, the load can be suitably distributed (transmitted) to the entire region of the panel. Thereby, by the distributed load, it is possible to suitably deform the entire region of the panel.

(3) In the aspect described above, the side frame may be provided on a vehicle rear part, and the plurality of stiffness change regions may be provided close to a rear end portion of the side frame.

According to such a configuration, when an impact load is input from a vehicle rearward direction, by deforming the rear end portion side of the side frame so as to be bent to the vehicle width direction outer side and the vehicle width direction inner side, the load can be absorbed.

By the rear end portion side of the side frame being bent to the vehicle width direction outer side and the vehicle width direction inner side, the load is transmitted from the rear end portion side of the side frame to a rear end portion side of the panel.

Specifically, a load that compresses the rear end portion side of the panel to the vehicle width direction inner side or a load that extends the rear end portion side of the panel to the vehicle width direction outer side is transmitted from the rear end portion side of the side frame to the rear end portion side of the panel. Further, a load that deforms the rear end portion side of the panel in a vehicle forward direction is transmitted from the rear end portion side of the side frame to the panel. Thereby, it is possible to efficiently transmit the load from the rear end portion side of the panel to the entire region of the panel.

Additionally, by providing the plurality of stiffness change regions on the rear end portion side of the side frame, when an impact load is input from the vehicle rearward direction, the rear end portion side of the side frame can be bent in the vehicle width direction before the panel is substantially deformed in the vehicle forward direction. Thereby, it is possible to efficiently transmit the load to the entire region of the panel while absorbing the impact load by the side frame.

As a result, the load can be suitably distributed to the entire region of the panel having a large area while absorbing the impact load by the side frame, and the load absorption efficiency by the panel can be improved.

(4) In the aspect described above, the side frame may be provided on a vehicle front part, and the plurality of stiffness change regions may be provided close to a front end portion of the side frame.

According to such a configuration, when an impact load is input from a vehicle forward direction, by deforming the front end portion side of the side frame so as to be bent to the vehicle width direction outer side and the vehicle width direction inner side, the load can be absorbed.

By the front end portion side of the side frame being bent to the vehicle width direction outer side and the vehicle width direction inner side, the load is transmitted from the front end portion side of the side frame to a front end portion side of the panel.

Specifically, a load that compresses the front end portion side of the panel to the vehicle width direction inner side or a load that extends the front end portion side of the panel to the vehicle width direction outer side is transmitted from the front end portion side of the side frame to the front end portion side of the panel. Further, a load that deforms the front end portion side of the panel in a vehicle rearward direction is transmitted from the front end portion side of the side frame to the panel. Thereby, it is possible to efficiently transmit the load from the front end portion side of the panel to the entire region of the panel.

Additionally, by providing the plurality of stiffness change regions on the front end portion side of the side frame, when an impact load is input from the vehicle forward direction, the front end portion side of the side frame can be bent in the vehicle width direction before the panel is substantially deformed in the vehicle rearward direction. Thereby, it is possible to efficiently transmit the load to the entire region of the panel while absorbing the impact load by the side frame.

As a result, the load can be suitably distributed to the entire region of the panel having a large area while absorbing the impact load by the side frame, and the load absorption efficiency by the panel can be improved.

(5) In the aspect described above, the fragile portion and the stiffness change region may be provided at an overlapping position in the vehicle forward-rearward direction.

According to such a configuration, by the fragile portion being deformed by an impact load input to the side frame from the vehicle forward-rearward direction, it is possible to promote deformation in the vehicle forward-rearward direction of the side frame.

The fragile portion is provided at a position that overlaps (laps) with the stiffness change region in the vehicle forward-rearward direction. Therefore, it is possible to prevent stress concentration on the stiffness change regions provided at different positions in the longitudinal direction of the side frame. By preventing stress concentration on the stiffness change regions provided at different positions, it is possible to prevent buckling of the side frame in the vehicle forward-rearward direction.

Accordingly, the side frame can be reliably bent to the vehicle width direction outer side and the vehicle width direction inner side from the stiffness change region as a starting point. As a result, a load that compresses the panel to the vehicle width direction inner side or a load that extends the panel to the vehicle width direction outer side can be reliably transmitted from the side frame to the panel.

According to the aspect of the present invention, it is possible to improve the load absorption efficiency by providing the side frame and the panel, and the aspect of the present invention contributes to the development of a sustainable transportation system.

### BRIEF DESCRIPTION OF THE DRAWINGS

FIG. 1 is a perspective view of a vehicle body structure when seen from a vehicle forward leftward direction in an embodiment of the present invention.

FIG. 2 is a side view of the vehicle body structure when seen from a vehicle width direction left side in the embodiment of the present invention.

FIG. 3 is a perspective view of a left rear side frame of the vehicle body structure when seen from a vehicle forward leftward side in the embodiment of the present invention.

FIG. 4 is a plan view of the left rear side frame of the vehicle body structure when seen from an upward direction in the embodiment of the present invention.

FIG. 5 is a plan view showing transmission of an impact load that is input from a vehicle rearward direction to a rear floor structure of the vehicle body structure in the embodiment of the present invention.

FIG. 6 is a plan view showing a front floor structure of a modification example in the embodiment of the present invention.

### DESCRIPTION OF EMBODIMENTS

Hereinafter, a vehicle body structure according to an embodiment of the present invention will be described with reference to the drawings. In the drawings, an arrow FR indicates a forward direction of a vehicle, an arrow UP indicates an upward direction of the vehicle, and an arrow LH indicates a leftward direction of the vehicle.

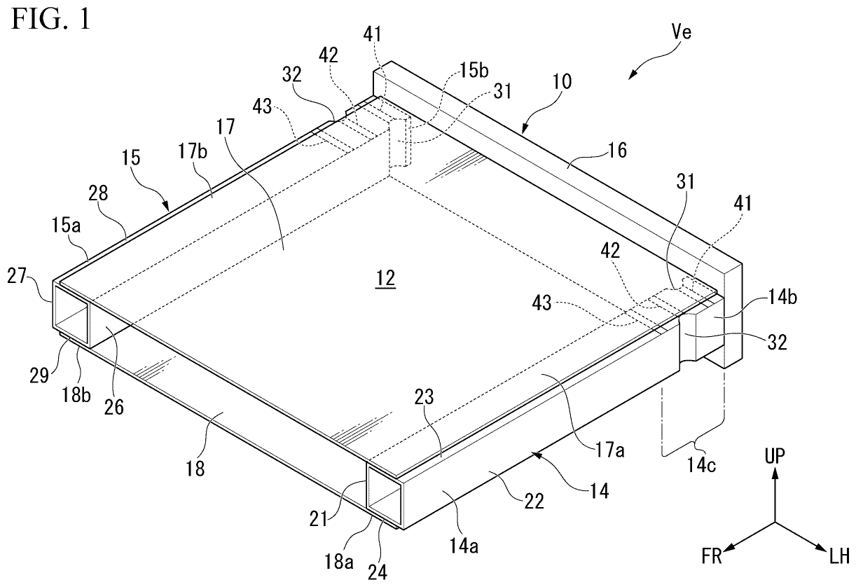

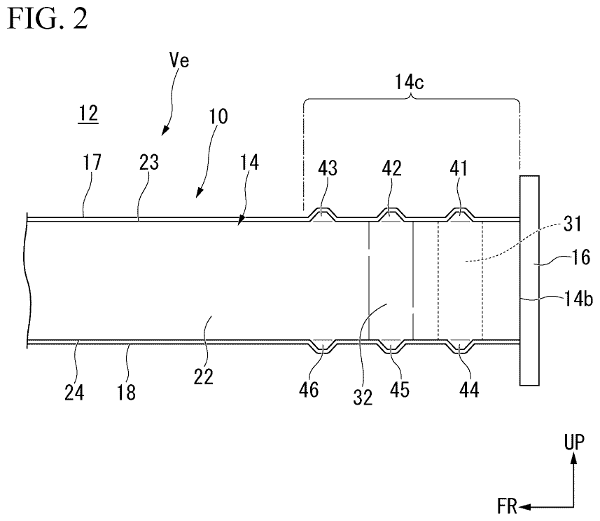

FIG. 1 is a perspective view of a vehicle body structure when seen from a vehicle forward leftward direction. FIG. 2 is a side view of the vehicle body structure when seen from a vehicle width direction left side.

### <Vehicle Body Structure>

As shown in FIG. 1 and FIG. 2, a vehicle body structure Ve includes a rear floor structure 10 at a lower portion of a rear load room 12 in a vehicle rear part. The rear floor structure 10 includes: for example, a left rear side frame (side frame) 14 and a right rear side frame (side frame) 15 that are arranged on respective sides in a vehicle width direction; a rear bumper beam 16 that is provided on and between rear end portions 14b, 15b of the rear side frames 14, 15; an upper panel (panel) 17 that is provided on an upper surface 23, 28 of each rear side frame 14, 15; and a lower panel (panel) 18 that is provided on a lower surface 24, 29 of each rear side frame 14, 15.

The left rear side frame 14 is provided on a lower portion on the left side in the vehicle width direction in the rear load room 12. The left rear side frame 14 extends in a vehicle rearward direction from a front end portion 14a toward a rear end portion 14b in a vehicle forward-rearward direction.

The left rear side frame 14 has an inner side surface 21 on a vehicle width direction inner side, an outer side surface 22 on a vehicle width direction outer side, an upper surface 23 on a vehicle upper side, and a lower surface 24 on a vehicle lower side. That is, the inner side surface 21 and the outer side surface 22 are formed to be separated to the vehicle width direction inner side and the vehicle width direction outer side so as not to form the entire circumference of the left rear side frame 14. The left rear side frame 14 is formed of the inner side surface 21, the outer side surface 22, the upper surface 23, and the lower surface 24 in a hollow shape having a rectangular cross section.

The right rear side frame 15 is provided on a lower portion on the right side in the vehicle width direction in the rear load room 12. The right rear side frame 15 extends in the vehicle rearward direction from a front end portion 15a toward a rear end portion 15b in the vehicle forward-rearward direction. That is, the right rear side frame 15 extends toward the vehicle rearward direction along the left rear side frame 14.

The right rear side frame 15 has an inner side surface 26 on a vehicle width direction inner side, an outer side surface 27 on a vehicle width direction outer side, an upper surface 28 on a vehicle upper side, and a lower surface 29 on a vehicle lower side. That is, the inner side surface 26 and the outer side surface 27 are formed to be separated to the vehicle width direction inner side and the vehicle width direction outer side so as not to form the entire circumference of the right rear side frame 15. The right rear side frame 15 is formed of the inner side surface 26, the outer side surface 27, the upper surface 28, and the lower surface 29 in a hollow shape having a rectangular cross section.

The present embodiment is described using an example in which the left rear side frame 14 and the right rear side frame 15 are formed in a rectangular hollow body; however, the embodiment is not limited thereto. As another example, the left rear side frame and the right rear side frame may be formed of a frame member having a U shape in cross section that opens at an upper portion and an upper frame portion that closes the upper portion of the frame member in a rectangular hollow body. Alternatively, the left rear side frame 14 and the right rear side frame 15 may be formed in a circular hollow body.

The rear bumper beam 16 extends in the vehicle width direction. The left rear side frame 14, the right rear side frame 15, and the rear bumper beam 16 are members having high stiffness that constitute a skeleton of the vehicle body structure Ve (specifically, the rear floor structure 10).

The upper panel 17 and the lower panel 18 are provided on a lower portion (vehicle lower part) of the rear load room 12 and form a floor portion of the rear load room 12. Specifically, the upper panel 17 is formed of a plate material having a substantially rectangular shape in a top view. A vehicle width direction left outer side portion (vehicle width direction outer side) 17a of the upper panel 17 is connected to the upper surface 23 of the left rear side frame 14 from a vehicle upward direction. A vehicle width direction right outer side portion (vehicle width direction outer side) 17b of the upper panel 17 is connected to the upper surface 28 of the right rear side frame 15 from the vehicle upward direction.

The lower panel 18 is formed of a plate material having a substantially rectangular shape in a top view. A vehicle width direction left outer side portion (vehicle width direction outer side) 18a of the lower panel 18 is connected to the lower surface 24 of the left rear side frame 14 from a vehicle downward direction. A vehicle width direction right outer side portion (vehicle width direction outer side) 18b of the lower panel 18 is connected to the lower surface 29 of the right rear side frame 15 from the vehicle downward direction.

That is, the left rear side frame 14 extends in the vehicle forward-rearward direction in a state where the left rear side frame 14 is connected to a vehicle lower surface of the upper panel 17 and the vehicle width direction left outer side portion 17a and is connected to a vehicle upper surface of the lower panel 18 and the vehicle width direction left outer side portion 18a.

The right rear side frame 15 extends in the vehicle forward-rearward direction in a state where the right rear side frame 15 is connected to the vehicle lower surface of the upper panel 17 and the vehicle width direction right outer side portion 17b and is connected to the vehicle upper surface of the lower panel 18 and the vehicle width direction right outer side portion 18b.

The present embodiment is described using an example in which the rear floor structure 10 includes the upper panel 17 and the lower panel 18; however, the embodiment is not limited thereto. Only the upper panel 17 may be connected to the upper surface 23 of the left rear side frame 14 and the upper surface 28 of the right rear side frame 15. Only the lower panel 18 may be connected to the lower surface 24 of the left rear side frame 14 and the lower surface 29 of the right rear side frame 15.

### <Rear Side Frame>

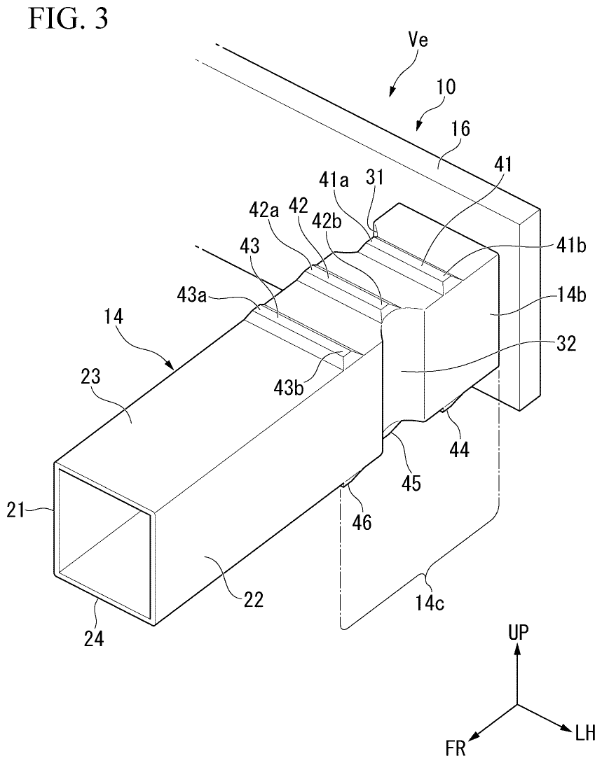

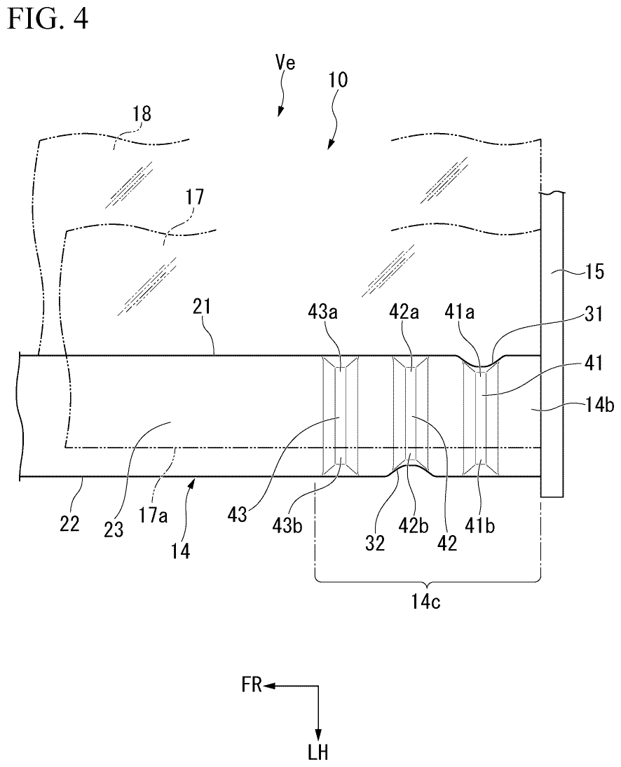

FIG. 3 is a perspective view of the left rear side frame of the vehicle body structure when seen from a vehicle forward leftward side. FIG. 4 is a plan view of the left rear side frame of the vehicle body structure when seen from an upward direction.

The left rear side frame 14 has a plurality of stiffness change regions 31, 32 and a plurality of fragile portions 41 to 46. The present embodiment is described using an example in which two stiffness change regions, namely a first stiffness change region 31 and a second stiffness change region 32, are shown as the plurality of stiffness change regions 31, 32. The number of stiffness change regions is not limited to two and may be arbitrarily selected.

The first stiffness change region 31 and the second stiffness change region 32 are provided on a rear portion 14c on the rear end portion 14b side of the left rear side frame 14. The rear portion 14c is located at a vehicle rearward position further than the middle of the left rear side frame 14 in the vehicle forward-rearward direction and close to the rear end portion 14b of the left rear side frame 14. The term “close to the rear end portion 14b” means that the position does not necessarily have to be completely in contact with the rear end portion 14b. The present embodiment is described using an example in which a region from the rear end portion 14b to a position separated by a predetermined distance in a vehicle forward direction from the rear end portion 14b is the rear portion 14c.

The first stiffness change region 31 is provided, for example, on the inner side surface 21 of the left rear side frame 14 at a position close to the rear end portion 14b of the left rear side frame 14 that is nearest to the rear bumper beam 16. The first stiffness change region 31 is formed so as to be recessed in a curved shape from the inner side surface 21 of the left rear side frame 14 toward a vehicle width direction outer side (that is, an inner side of the left rear side frame 14) and extends in a vehicle upward-downward direction. Therefore, the first stiffness change region 31 is formed such that the stiffness changes in the vehicle forward-rearward direction of the left rear side frame 14.

The second stiffness change region 32 is provided, for example, on the outer side surface 22 of the left rear side frame 14 at a position spaced apart in the vehicle forward direction from the first stiffness change region 31. That is, the second stiffness change region 32 is provided at a different position in the longitudinal direction from the first stiffness change region 31. The longitudinal direction refers to a longitudinal direction (that is, the vehicle forward-rearward direction) of the left rear side frame 14.

The second stiffness change region 32 is formed so as to be recessed in a curved shape from the outer side surface 22 of the left rear side frame 14 toward a vehicle width direction inner side (that is, an inner side of the left rear side frame 14) and extends in the vehicle upward-downward direction. Therefore, the second stiffness change region 32 is formed such that the stiffness changes in the vehicle forward-rearward direction of the left rear side frame 14.

The first stiffness change region 31 is thus provided on the inner side surface 21 of the left rear side frame 14. The second stiffness change region 32 is provided on the outer side surface 22 of the left rear side frame 14. The first stiffness change region 31 and the second stiffness change region 32 are provided to be spaced apart from each other in the vehicle forward-rearward direction.

Therefore, when an impact load is input to the left rear side frame 14 from the vehicle rearward direction, the left rear side frame 14 is bent to the vehicle width direction outer side from the first stiffness change region 31 as a starting point. The left rear side frame 14 is bent to the vehicle width direction inner side from the second stiffness change region 32 as a starting point. That is, the left rear side frame 14 is deformed so as to be bent to the vehicle width direction outer side and the vehicle width direction inner side from the first stiffness change region 31 and the second stiffness change region 32 as starting points.

The present embodiment is described using an example in which the first stiffness change region 31 is provided on the inner side surface 21 of the left rear side frame 14, and the second stiffness change region 32 is provided on the outer side surface 22 of the left rear side frame 14; however, the embodiment is not limited thereto. As another example, the first stiffness change region 31 may be provided on the outer side surface 22 of the left rear side frame 14, and the second stiffness change region 32 may be provided on the inner side surface 21 of the left rear side frame 14.

The present embodiment is described using an example in which the first stiffness change region 31 and the second stiffness change region 32 are formed so as to be recessed in a curved shape toward the inner side of the left rear side frame 14; however, the embodiment is not limited thereto. As another example, the first stiffness change region and the second stiffness change region may be formed so as to protrude toward the outer side of the left rear side frame 14. Alternatively, the first stiffness change region and the second stiffness change region may be formed by forming an opening portion in the left rear side frame 14 or by varying the thickness (plate thickness) of the left rear side frame 14.

The plurality of fragile portions 41 to 46 are provided on the rear portion 14c of the left rear side frame 14.

The present embodiment is described using an example in which six fragile portions, namely a first fragile portion 41, a second fragile portion 42, a third fragile portion 43, a fourth fragile portion 44, a fifth fragile portion 45, and a sixth fragile portion 46, are shown as the plurality of fragile portions 41 to 46.

The number of fragile portions is not limited to six and may be arbitrarily selected.

The first fragile portion 41, the second fragile portion 42, and the third fragile portion 43 are provided at intervals in the vehicle forward-rearward direction on the upper surface 23 of the rear portion 14c of the left rear side frame 14. The first fragile portion 41, the second fragile portion 42, and the third fragile portion 43 are continuous in the vehicle width direction, for example, in a shape that protrudes in a vehicle upward direction from the upper surface 23.

The first fragile portion 41 is provided at a position that overlaps (laps) with the first stiffness change region 31 in the vehicle forward-rearward direction. In the first fragile portion 41, for example, in the vehicle width direction, an inner end 41a is connected to the first stiffness change region 31, and an outer end 41b is connected to the outer side surface 22 of the left rear side frame 14. In the first fragile portion 41, the inner end 41a may be separated from the first stiffness change region 31, and the outer end 41b may be separated from the outer side surface 22 of the left rear side frame 14.

The second fragile portion 42 is provided at a vehicle forward side of the first fragile portion 41 and is provided at a position that overlaps (laps) with the second stiffness change region 32 in the vehicle forward-rearward direction. In the second fragile portion 42, for example, in the vehicle width direction, an inner end 42a is connected to the inner side surface 21 of the left rear side frame 14, and an outer end 42b is connected to the second stiffness change region 32. In the second fragile portion 42, the inner end 42a may be separated from the inner side surface 21 of the left rear side frame 14, and the outer end 42b may be separated from the second stiffness change region 32.

The third fragile portion 43 is provided at a vehicle forward side of the second fragile portion 42. The distance in the vehicle forward-rearward direction from the third fragile portion 43 to the second fragile portion 42 is, for example, the same as the distance in the vehicle forward-rearward direction between the first fragile portion 41 and the second fragile portion 42. In the third fragile portion 43, for example, in the vehicle width direction, an inner end 43a is connected to the inner side surface 21 of the left rear side frame 14, and an outer end 43b is connected to the outer side surface 22 of the left rear side frame 14. In the third fragile portion 43, the inner end 43a may be separated from the inner side surface 21 of the left rear side frame 14. The outer end 43b may be separated from the outer side surface 22 of the left rear side frame 14.

The fourth fragile portion 44, the fifth fragile portion 45, and the sixth fragile portion 46 are provided at intervals in the vehicle forward-rearward direction on the lower surface 24 of the rear portion 14c of the left rear side frame 14. The fourth fragile portion 44, the fifth fragile portion 45, and the sixth fragile portion 46 are continuous in the vehicle width direction, for example, in a shape that protrudes in a vehicle downward direction from the lower surface 24.

The fourth fragile portion 44 is provided at a position that overlaps (laps) with the first stiffness change region 31 in the vehicle forward-rearward direction. The fourth fragile portion 44 is formed symmetrically in the upward-downward direction with respect to the first fragile portion 41. Therefore, detailed descriptions of the fourth fragile portion 44 are omitted.

The fifth fragile portion 45 is provided at a vehicle forward side of the fourth fragile portion 44 at a position that overlaps (laps) with the second stiffness change region 32. The fifth fragile portion 45 is formed symmetrically in the upward-downward direction with respect to the second fragile portion 42. Therefore, detailed descriptions of the fifth fragile portion 45 are omitted.

The sixth fragile portion 46 is provided at a vehicle forward side of the fifth fragile portion 45. The distance in the vehicle forward-rearward direction from the sixth fragile portion 46 to the fifth fragile portion 45 is, for example, the same as the distance in the vehicle forward-rearward direction between the fourth fragile portion 44 and the fifth fragile portion 45. The sixth fragile portion 46 is formed symmetrically in the upward-downward direction with respect to the third fragile portion 43. Therefore, detailed descriptions of the sixth fragile portion 46 are omitted.

The present embodiment is described using an example in which the first fragile portion 41 to the sixth fragile portion 46 are formed so as to protrude toward the outer side of the left rear side frame 14; however, the embodiment is not limited thereto. As another example, the first fragile portion to the sixth fragile portion may be formed so as to be recessed in a curved shape toward the inner side of the left rear side frame 14. Alternatively, the first fragile portion to the sixth fragile portion may be formed by forming an opening portion in the left rear side frame 14 or by thinning the thickness (plate thickness) of the left rear side frame 14.

As shown in FIG. 1, the right rear side frame 15 is formed symmetrically in the rightward-leftward direction with respect to the left rear side frame 14 in the vehicle width direction. Therefore, the plurality of stiffness change regions and the plurality of fragile portions provided on the right rear side frame 15 are denoted by the same reference numerals as those of the first stiffness change region 31, the second stiffness change region 32, and the first fragile portion 41 to the sixth fragile portion 46 of the left rear side frame 14, and detailed descriptions thereof are omitted.

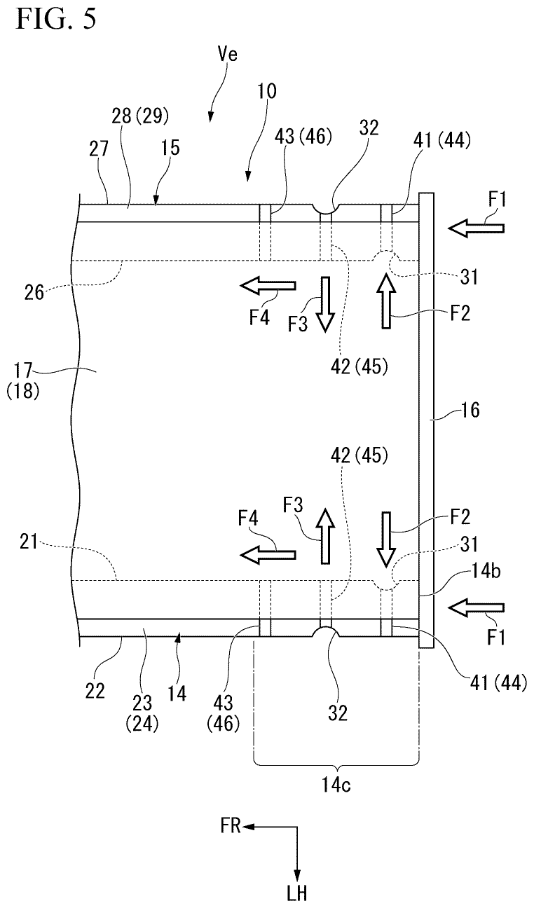

Next, with reference to FIG. 2 and FIG. 5, an example is described in which, when an impact load F1 is input to the rear floor structure 10 of the vehicle body structure Ve from the vehicle rearward direction, the input impact load F1 is absorbed by the rear floor structure 10.

FIG. 5 is a plan view showing transmission of an impact load that is input from a vehicle rearward direction to the rear floor structure of the vehicle body structure.

As shown in FIG. 2 and FIG. 5, the first stiffness change region 31 is provided on the inner side surface 21 of the left rear side frame 14, and the second stiffness change region 32 is provided on the outer side surface 22 of the left rear side frame 14.

The first stiffness change region 31 is provided on the inner side surface 26 of the right rear side frame 15, and the second stiffness change region 32 is provided on the outer side surface 27 of the right rear side frame 15. In this state, the impact load F1 is input to the rear floor structure 10 from the vehicle rearward direction.

When the impact load F1 is input to the rear floor structure 10, the left rear side frame 14 can be deformed so as to be bent to the vehicle width direction outer side and the vehicle width direction inner side from the first stiffness change region 31 and the second stiffness change region 32 as starting points. Similarly, the right rear side frame 15 can be deformed so as to be bent to the vehicle width direction outer side and the vehicle width direction inner side from the first stiffness change region 31 and the second stiffness change region 32 as starting points. By the left side frame 14 and the right rear side frame 15 deforming so as to be bent, the input impact load F1 is absorbed.

The upper panel 17 is connected to the upper surface 23 of the left rear side frame 14 and the upper surface 28 of the right rear side frame 15. The lower panel 18 is connected to the lower surface 24 of the left rear side frame 14 and the lower surface 29 of the right rear side frame 15. By the left rear side frame 14 and the right rear side frame 15 being deformed so as to bend to the vehicle width direction outer side and the vehicle width direction inner side, a load is transmitted from the left rear side frame 14 and the right rear side frame 15 to the upper panel 17 and the lower panel 18.

Specifically, a load F2 that extends the upper panel 17 and the lower panel 18 to the vehicle width direction outer side or a load F3 that compresses the upper panel 17 and the lower panel 18 to the vehicle width direction inner side is transmitted from the left rear side frame 14 and the right rear side frame 15 to the upper panel 17 and the lower panel 18.

Further, a load F4 that deforms the upper panel 17 and the lower panel 18 in the vehicle forward direction is transmitted from the left rear side frame 14 and the right rear side frame 15 to the upper panel 17 and the lower panel 18.

Thereby, it is possible to efficiently transmit the load to the entire region of the upper panel 17 and the lower panel 18, and it is possible to suitably deform the entire region of the upper panel 17 and the lower panel 18.

Additionally, the first stiffness change region 31 and the second stiffness change region 32 of the left rear side frame 14 are provided at a different position in the vehicle forward-rearward direction. The first stiffness change region 31 and the second stiffness change region 32 of the right rear side frame 15 are provided at a different position in the vehicle forward-rearward direction.

Thereby, the left rear side frame 14 can be deformed so as to be suitably bent in the vehicle width direction from the first stiffness change region 31 and the second stiffness change region 32 as starting points without concentrating stress on part of the left rear side frame 14. The right rear side frame 15 can be deformed so as to be suitably bent in the vehicle width direction from the first stiffness change region 31 and the second stiffness change region 32 as starting points without concentrating stress on part of the right rear side frame 15.

As described above, according to the rear floor structure 10, the left rear side frame 14 and the right rear side frame 15 can be deformed so as to be suitably bent in the vehicle width direction. Additionally, according to the rear floor structure 10, the entire region of the upper panel 17 and the lower panel 18 can be suitably deformed.

Thereby, it is possible to improve the load absorption efficiency by the left rear side frame 14, the right rear side frame 15, the upper panel 17, and the lower pane 18. Further, it is possible to contribute to the development of a sustainable transportation system.

The left rear side frame 14 and the right rear side frame 15 are formed symmetrically in the rightward-leftward direction. The left rear side frame 14 is described below, and detailed descriptions of the right rear side frame 15 are omitted.

Each of the first fragile portion 41, the second fragile portion 42, and the third fragile portion 43 is provided so as to be continuous in the vehicle width direction on the upper surface 23 of the left rear side frame 14. Each of the fourth fragile portion 44, the fifth fragile portion 45, and the sixth fragile portion 46 is provided so as to be continuous in the vehicle width direction on the lower surface 24 of the left rear side frame 14.

Therefore, the first fragile portion 41 to the sixth fragile portion 46 can be deformed together with the first stiffness change region 31 and the second stiffness change region 32. Thereby, it is possible to further suitably promote deformation of bending the left rear side frame 14 in the vehicle width direction from the first stiffness change region 31 and the second stiffness change region 32 as starting points.

It is possible to prevent buckling of the left rear side frame 14 by stress concentration and suitably bend the left rear side frame 14 in the vehicle width direction from the first stiffness change region 31 and the second stiffness change region 32 as starting points. Therefore, the load can be suitably distributed (transmitted) to the entire region of the upper panel 17 and the lower panel 18. Thereby, by the distributed load, it is possible to suitably deform the entire region of the upper panel 17 and the lower panel 18.

The first stiffness change region 31 and the second stiffness change region 32 are provided on the rear portion 14c of the left rear side frame 14. Therefore, when the impact load F1 is input from the vehicle rearward direction, by deforming the rear portion 14c of the left rear side frame 14 so as to be bent to the vehicle width direction outer side and the vehicle width direction inner side, the load can be absorbed.

By the rear portion 14c of the left rear side frame 14 being bent to the vehicle width direction outer side and the vehicle width direction inner side, the load is transmitted from the rear portion 14c of the left rear side frame 14 to the rear end portion side of the upper panel 17 and the lower panel 18.

Specifically, the load F2 that extends the rear end portion side of the upper panel 17 and the lower panel 18 to the vehicle width direction outer side or a load F3 that compresses the rear end portion side of the upper panel 17 and the lower panel 18 to the vehicle width direction inner side is transmitted from the rear portion 14c of the left rear side frame 14 to the rear end portion side of the upper panel 17 and the lower panel 18. The load F4 that deforms the rear end portion side of the upper panel 17 and the lower panel 18 in the vehicle forward direction is transmitted from the rear portion 14c of the left rear side frame 14 to the upper panel 17 and the lower panel 18. Thereby, it is possible to efficiently transmit the load from the rear end portion side of the upper panel 17 and the lower panel 18 to the entire region of the upper panel 17 and the lower panel 18.

The first stiffness change region 31 and the second stiffness change region 32 are provided on the rear portion 14c of the left rear side frame 14. Therefore, when the impact load F1 is input from the vehicle rearward direction, the rear portion 14c can be bent in the vehicle width direction before the upper panel 17 and the lower panel 18 are substantially deformed in the vehicle forward direction. Thereby, it is possible to efficiently transmit the load to the entire region of the upper panel 17 and the lower panel 18 while absorbing the impact load F1 by the left rear side frame 14.

As a result, the load can be suitably distributed to the entire region of the upper panel 17 and the lower panel 18 having a large area while absorbing the impact load F1 by the left rear side frame 14, and the load absorption efficiency by the upper panel 17 and the lower panel 18 can be improved.

Additionally, the first fragile portion 41 and the first stiffness change region 31 are provided at an overlapping position in the vehicle forward-rearward direction. The second fragile portion 42 and the second stiffness change region 32 are provided at an overlapping position in the vehicle forward-rearward direction. Therefore, by the first fragile portion 41 and the second fragile portion 42 being deformed by the impact load F1 input to the left rear side frame 14 from the vehicle rearward direction, it is possible to promote deformation in the vehicle forward direction of the left rear side frame 14.

The first fragile portion 41 is provided at a position that overlaps the first stiffness change region 31 in the vehicle forward-rearward direction. The second fragile portion 42 is provided at a position that overlaps the second stiffness change region 32 in the vehicle forward-rearward direction. Therefore, it is possible to prevent stress concentration on the first stiffness change region 31 and the second stiffness change region 32 provided at different positions in the longitudinal direction (that is, the vehicle forward-rearward direction) of the left rear side frame 14. By preventing stress concentration on the first stiffness change region 31 and the second stiffness change region 32, it is possible to prevent buckling of the left rear side frame 14 in the vehicle forward-rearward direction.

Accordingly, the left rear side frame 14 can be reliably bent to the vehicle width direction outer side and the vehicle width direction inner side from the first stiffness change region 31 and the second stiffness change region 32 as starting points. As a result, a load F2 that extends the upper panel 17 and the lower panel 18 to the vehicle width direction outer side or a load F3 that compresses the upper panel 17 and the lower panel 18 to the vehicle width direction inner side can be reliably transmitted from the left rear side frame 14 to the upper panel 17 and the lower panel 18.

### Modification Example

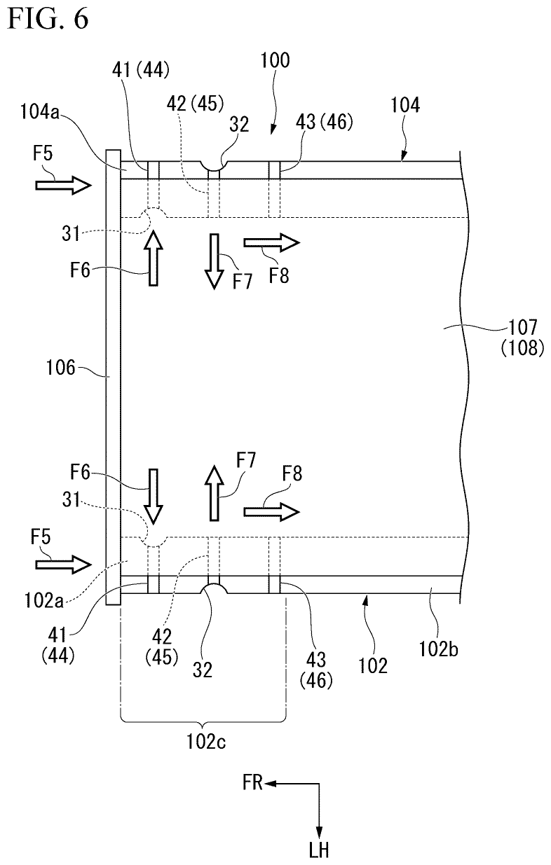

The present embodiment is described using an example in which the present invention is applied to the rear floor structure 10 at the vehicle rear part; however, the embodiment is not limited thereto. As another modification example, the present invention can also be applied to a front floor structure provided on a vehicle front part. Hereinafter, a front floor structure 100 of a modification example is described with reference to FIG. 6. In the modification example, the same or similar members to those of the rear floor structure 10 of the embodiment are denoted by the same reference numerals, and detailed descriptions thereof are omitted.

FIG. 6 is a plan view showing a front floor structure of a modification example.

As shown in FIG. 6, the front floor structure 100 of the modification example is provided on a vehicle front part. The front floor structure 100 includes a left front side frame (side frame) 102 and a right front side frame (side frame) 104. A front bumper beam 106 is provided on and between a front end portion 102a of the left front side frame 102 and a front end portion 104a of the right front side frame 104. An upper panel (panel) 107 is joined to upper surfaces of the left front side frame 102 and the right front side frame 104 from an upward direction. Further, a lower panel (panel) 108 is joined to lower surfaces of the left front side frame 102 and the right front side frame 104 from a downward direction.

The left front side frame 102 is provided on a lower portion on the left side in the vehicle width direction at a vehicle forward position. The left front side frame 102 extends toward a vehicle forward direction from a rear end portion 102b to a front end portion 102a in the vehicle forward-rearward direction. The first stiffness change region 31, the second stiffness change region 32, and the first fragile portion 41 to the sixth fragile portion 46 are provided on a front portion 102c of the left front side frame 102.

The front portion 102c is located at a vehicle forward position further than the middle of the left front side frame 102 in the vehicle forward-rearward direction and close to the front end portion 102a of the left front side frame 102.

The term “close to the front end portion 102a” means that the position does not necessarily have to be completely in contact with the front end portion 102a. The modification example is described using an example in which a region from the front end portion 102a to a position separated by a predetermined distance in a vehicle rearward direction from the front end portion 102a is the front portion 102c.

The right front side frame 104 is formed symmetrically in the rightward-leftward direction with respect to the left front side frame 102 in the vehicle width direction. Therefore, the plurality of stiffness change regions and the plurality of fragile portions provided on the right front side frame 104 are denoted by the same reference numerals as those of the first stiffness change region 31, the second stiffness change region 32, and the first fragile portion 41 to the sixth fragile portion 46 of the left front side frame 102, and detailed descriptions thereof are omitted.

According to the front floor structure 100 of the modification example described above, the left front side frame 102 and the right front side frame 104 can be deformed so as to be suitably bent in the vehicle width direction. Additionally, according to the front floor structure 100, the entire region of the upper panel 107 and the lower panel 108 can be suitably deformed.

Thereby, it is possible to improve the load absorption efficiency by the left front side frame 102, the right front side frame 104, the upper panel 107, and the lower panel 108.

Further, it is possible to contribute to the development of a sustainable transportation system.

The left front side frame 102 and the right front side frame 104 are formed symmetrically in the rightward-leftward direction. Therefore, the left front side frame 102 is described below, and detailed descriptions of the right front side frame 104 are omitted.

The first stiffness change region 31 and the second stiffness change region 32 are provided on the front portion 102c of the left front side frame 102. Therefore, when an impact load F5 is input from the vehicle forward direction, by deforming the front portion 102c of the left front side frame 102 so as to be bent to the vehicle width direction outer side and the vehicle width direction inner side, the load can be absorbed.

By the front portion 102c of the left front side frame 102 being bent to the vehicle width direction outer side and the vehicle width direction inner side, the load is transmitted from the front portion 102c of the left front side frame 102 to a front end portion side of the upper panel 107 and the lower panel 108.

That is, a load F6 that extends the front end portion side of the upper panel 107 and the lower panel 108 to the vehicle width direction outer side or a load F7 that compresses the front end portion side of the upper panel 107 and the lower panel 108 to the vehicle width direction inner side is transmitted from the front portion 102c of the left front side frame 102 to the front end portion side of the upper panel 107 and the lower panel 108. A load F8 that deforms the front end portion side of the upper panel 107 and the lower panel 108 in the vehicle rearward direction is transmitted from the front portion 102c of the left front side frame 102 to the upper panel 107 and the lower panel 108. Thereby, it is possible to efficiently transmit the load from the front end portion side of the upper panel 107 and the lower panel 108 to the entire region of the upper panel 107 and the lower panel 108.

Additionally, the first stiffness change region 31 and the second stiffness change region 32 are provided on the front portion 102c of the left front side frame 102. Therefore, when the impact load F5 is input from the vehicle forward direction, the front portion 102c can be bent in the vehicle width direction before the upper panel 107 and the lower panel 108 are substantially deformed in the vehicle rearward direction. Thereby, it is possible to efficiently transmit the load to the entire region of the upper panel 107 and the lower panel 108 while absorbing the impact load F5 by the left front side frame 102.

As a result, the load can be suitably distributed to the entire region of the upper panel 107 and the lower panel 108 having a large area while absorbing the impact load F5 by the left front side frame 102, and the load absorption efficiency by the upper panel 107 and the lower panel 108 can be improved.

According to the front floor structure 100 of the modification example, it is possible to obtain actions and effects similar to those of the rear floor structure 10 of the embodiment described above.

The technical scope of the present invention is not limited to the embodiments described above, and various modifications can be added without departing from the scope of the present invention.

The components in the embodiments described above can be appropriately replaced by known components without departing from the scope of the present invention, and the modification examples described above can be appropriately combined.

What is claimed is:

1. A vehicle body structure, comprising:
a panel provided on a vehicle lower part; and
a side frame that is connected to a vehicle width direction outer side of the panel and extends in a vehicle forward-rearward direction,
wherein the side frame has a plurality of stiffness change regions,
the plurality of stiffness change regions are provided on a vehicle width direction outer side and a vehicle width direction inner side of the side frame, and
the stiffness change region provided on the vehicle width direction outer side is provided at a different position in a longitudinal direction from the stiffness change region provided on the vehicle width direction inner side.

2. The vehicle body structure according to claim 1,
wherein a fragile portion that is continuous in a vehicle width direction is provided on a vehicle upper side and a vehicle lower side of the side frame.

3. The vehicle body structure according to claim 1,
wherein the side frame is provided on a vehicle rear part, and
the plurality of stiffness change regions are provided close to a rear end portion of the side frame.

4. The vehicle body structure according to claim 1,
wherein the side frame is provided on a vehicle front part, and
the plurality of stiffness change regions are provided close to a front end portion of the side frame.

5. The vehicle body structure according to claim 2,
wherein the fragile portion and the stiffness change region are provided at an overlapping position in the vehicle forward-rearward direction.
